(19) United States
(12) Patent Application Publication
(10) Pub. No.: US 2022/0201109 A1
(43) Pub. Date: Jun. 23, 2022

(54) BLUETOOTH HEADSET MODULE, MOBILE PHONE HOLDER AND DRIVING METHOD THEREOF

(71) Applicant: Quanqi LI, Xiamen, Fujian (CN)

(72) Inventor: Quanqi LI, Xiamen, Fujian (CN)

(21) Appl. No.: 17/312,464

(22) PCT Filed: Dec. 7, 2020
(86) PCT No.: PCT/CN2020/134246

§ 371 Date: Jun. 10, 2021

(51) Int. Cl. H04M 1/04; H04W 4/80

(52) U.S. Cl. CPC H04M 1/04; H04W 4/80

(57) ABSTRACT

The present invention discloses a Bluetooth headset module, a mobile phone holder, and a driving method thereof, the Bluetooth headset module includes a Bluetooth headset and a Bluetooth headset holder, the Bluetooth headset holder is telescopically mounted on a mobile phone holder, the mobile phone holder is provided with a circuit board and a drive assembly electrically connected with the circuit board, the drive assembly drives the Bluetooth headset holder to extend under a trigger of a calling signal, and the drive assembly is triggered to drive the Bluetooth headset holder to retract after the Bluetooth headset is put back into the Bluetooth headset holder. In the present invention, the Bluetooth headset base is triggered by the calling signal to extend, which is very convenient to use, and since the Bluetooth headset holder retracts into the mobile phone holder, it not only occupies less space, but also is more beautiful.

### TECHNICAL FIELD

The present invention relates to the field of mobile phone accessories, in particular to a Bluetooth headset module, a mobile phone holder having the Bluetooth headset module and a driving method of the Bluetooth headset module.

### BACKGROUND

Mobile phones and cars are two indispensable things in modern life. Since it is inconvenient and unsafe for drivers to use mobile phones while driving cars, it is necessary to have a device for placing mobile phones. Due to the space limitation of cars, there is no suitable place to receive mobile phones, for this reason, mobile phone holders have appeared on the market for placing mobile phones, however, the existing mobile phone holder can only be used to fix the mobile phone, when charging the mobile phone, it is necessary to use a data cable to charge the mobile phone, various wires will appear messy when wound together, and Long-term plugging and unplugging of the charging plug into the tail plug of the mobile phone will reduce the life of the tail plug of the mobile phone; in addition, most of the existing mobile phone holders cannot achieve the charging of a Bluetooth headset, therefore, the driver cannot prolong the service time of the Bluetooth headset during driving.

Chinese utility model patent CN209218161U discloses a multifunctional mobile phone holder, which includes a fixing assembly, a clamping assembly, a Bluetooth headset charging station and a wireless charging station, wherein the fixing assembly is arranged at a rear end of the clamping assembly, the wireless charging station is arranged at a front end of the clamping assembly, and the Bluetooth headset charging station is arranged at a side face of the fixing assembly; and the Bluetooth headset charging station is provided with a charging bin adapted to the Bluetooth headset, a first USB interface and a second USB interface, the first USB interface is electrically connected with a vehicle socket, and the second USB interface is electrically connected with the wireless charging station. This kind of mobile phone holder occupies a large space and is not beautiful since the Bluetooth headset charging station is arranged side by side on the side of the fixing assembly, and it is not convenient to take and place the Bluetooth headset.

### SUMMARY

The present invention aims to provide a Bluetooth headset module, a mobile phone holder having the Bluetooth headset module and a driving method of the Bluetooth headset module, so as to solve the above problems. To this end, the specific technical solutions adopted by the present invention are as follows:

According to an aspect of the present invention, a Bluetooth headset module is provided, which includes a Bluetooth headset and a Bluetooth headset holder, the Bluetooth headset holder is telescopically mounted on a mobile phone holder and is used to receive the Bluetooth headset and charge the Bluetooth headset, the mobile phone holder is provided with a circuit board and a drive assembly electrically connected with the circuit board, the circuit board is electrically connected with the Bluetooth headset holder, and the drive assembly is in driving connection with the Bluetooth headset holder, the Bluetooth headset holder is driven by the drive assembly to extend upon being triggered by a calling signal, and the drive assembly is triggered to drive the Bluetooth headset holder to retract after the Bluetooth headset is put back into the Bluetooth headset holder.

Further, the drive assembly includes a mounting holder, a motor and a gear transmission mechanism, the mounting holder is fixedly mounted in the mobile phone holder, the gear transmission mechanism is mounted on the mounting holder, the motor is electrically connected with the circuit board and is in driving connection with the gear transmission mechanism, the Bluetooth headset holder is slidably mounted on the mounting holder and is provided with a rack that is engaged with the gear transmission mechanism.

Further, the gear transmission mechanism includes a worm, a first gear set and a second gear set, the first gear set includes a first large gear and a first small gear that are coaxial, the second gear set includes a second large gear and a second small gear that are coaxial, the worm is fixedly mounted on an output shaft of the motor, the first large gear is engaged with the worm, the first small gear is engaged with the second large gear, and the second small gear is engaged with the rack.

Further, the Bluetooth headset holder and the Bluetooth headset are respectively provided with charging contacts and signal contacts corresponding to each other, the charging contacts and the signal contacts are electrically connected with the circuit board, and when receiving the calling signal, the Bluetooth headset sends the calling signal to the circuit board through the signal contacts, thereby triggering the drive assembly to drive the Bluetooth headset holder to extend; and after the Bluetooth headset is put back into the Bluetooth headset holder, the drive assembly is triggered to drive the Bluetooth headset holder to retract through the conduction of the charging contacts.

Further, the circuit board is provided with a Bluetooth chip, when receiving the calling signal, the Bluetooth chip triggers the drive assembly to drive the Bluetooth headset holder to extend, and the Bluetooth headset holder and the Bluetooth headset are respectively provided with charging contacts corresponding to each other, the charging contacts are electrically connected with the circuit board, and after the Bluetooth headset is put back into the Bluetooth headset holder, the drive assembly is triggered to drive the Bluetooth headset holder to retract through the conduction of the charging contacts.

According to another aspect of the present invention, there is also provided a mobile phone holder, wherein the mobile phone holder has a Bluetooth headset module as described above.

Further, the mobile phone holder includes a holder body and a clamping mechanism, the holder body is provided with a power interface for connecting an external power supply thereon, the clamping mechanism is mounted on the holder body for fixing the mobile phone on the holder body, the circuit board is mounted in the holder body and is electrically connected with the Bluetooth headset holder, the power interface and the drive assembly, and the drive assembly is mounted in the holder body.

Further, the clamping mechanism includes a left holding arm, a right holding arm, a lower support arm, a left gear, a right gear and a return spring, the left holding arm, the right holding arm and the lower support arm are movably mounted on a left side, a right side and a bottom of the holder body respectively, the left gear and the right gear are rotatably mounted on the circuit board, lower edges of the left holding arm and the right holding arm and left and right edges of the lower support arm are provided with teeth, the left gear is engaged with the lower edge of the left holding arm and the left edge of the lower support arm, the right gear is engaged with the lower edge of the right holding arm and the right edge of the lower support arm, an upper end of the return spring is fixed on the lower support arm, and a lower end of the return spring is fixed on the mounting holder.

Further, the mobile phone holder further includes a wireless charging module, the wireless charging module is mounted in the holder body, a wireless charging coil of the wireless charging module is close to a front face of the holder body and is electrically connected with the circuit board and is used to charge the mobile phone placed on the holder body.

According to another aspect of the present invention, there is also provided a driving method of the Bluetooth headset module, wherein the method includes the following steps:

providing a Bluetooth headset module, wherein the Bluetooth headset module includes a Bluetooth headset and a Bluetooth headset holder, wherein the Bluetooth headset holder is telescopically mounted on a mobile phone holder and is used to receive the Bluetooth headset and charge the Bluetooth headset, the mobile phone holder is provided with a circuit board and a drive assembly electrically connected with the circuit board, the circuit board is electrically connected with the Bluetooth headset holder, and the drive assembly is in driving connection with the Bluetooth headset holder;

triggering the drive assembly through a calling signal to drive the Bluetooth headset holder to extend; and

triggering the drive assembly to drive the Bluetooth headset holder to retract after the Bluetooth headset is put back into the Bluetooth headset holder.

Further, the Bluetooth headset holder and the Bluetooth headset are respectively provided with charging contacts and signal contacts corresponding to each other, the charging contacts and the signal contacts are electrically connected with the circuit board, and when receiving the calling signal, the Bluetooth headset sends the calling signal to the circuit board through the signal contacts, thereby triggering the drive assembly to drive the Bluetooth headset holder to extend; and after the Bluetooth headset is put back into the Bluetooth headset holder, the drive assembly is triggered to drive the Bluetooth headset holder to retract through the conduction of the charging contacts.

Further, the circuit board is provided with a Bluetooth chip, when receiving the calling signal, the Bluetooth chip triggers the drive assembly to drive the Bluetooth headset holder to extend, and the Bluetooth headset holder and the Bluetooth headset are respectively provided with charging contacts corresponding to each other, the charging contacts are electrically connected with the circuit board, and after the Bluetooth headset is put back into the Bluetooth headset holder, the drive assembly is triggered to drive the Bluetooth headset holder to retract through the conduction of the charging contacts.

By adopting the technical solution, the present invention has the beneficial effects that when there is an incoming call, the Bluetooth headset holder automatically extends, which is convenient for a driver to take out the Bluetooth headset; and when the Bluetooth headset is put back into the Bluetooth headset holder, the Bluetooth headset holder automatically retracts and charges the Bluetooth headset, which is very convenient to use, and since the Bluetooth headset holder retracts into the mobile phone holder, it not only occupies less space, but also is more beautiful.

### BRIEF DESCRIPTION OF THE DRAWINGS

To further illustrate respective embodiments, the present invention is provided with the accompanying drawings. The drawings are a part of the disclosure of the present invention, which are mainly used to illustrate embodiments, and can be taken in conjunction with the relative depiction in the description to explain the operation principle of the embodiments. With reference to these contents, other possible embodiments and the advantages of the present invention will be understood by those ordinarily skilled in the art. The components in the drawings are not drawn to scale, and similar component signs are usually used to represent similar components.

FIG. 1 is a perspective view of a mobile phone holder having a Bluetooth headset module according to an embodiment of the present invention;

FIG. 2 is a perspective view of the mobile phone holder shown in FIG. 1 with a Bluetooth headset holder in an extended state;

FIG. 3 is an exploded perspective view of the mobile phone holder shown in FIG. 1;

FIG. 4 is a perspective view of the mobile phone holder shown in FIG. 1 with an upper cover removed;

FIG. 5 is a structural diagram of a clamping mechanism of the mobile phone holder shown in FIG. 1; and

FIG. 6 is a structural diagram of the Bluetooth headset holder and a drive assembly of the mobile phone holder shown in FIG. 1.

### DETAILED DESCRIPTION OF THE EMBODIMENTS

The present invention will be further explained in conjunction with the drawings and the specific embodiments.

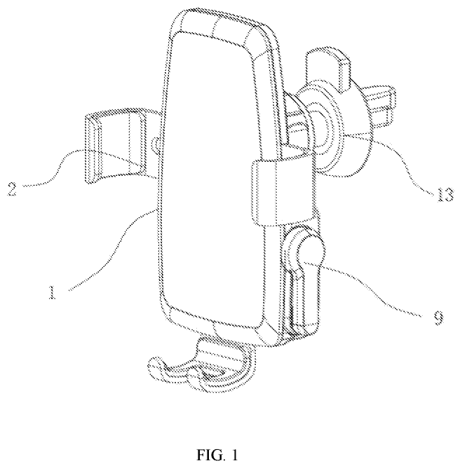

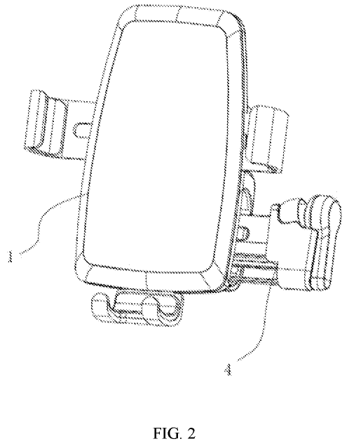

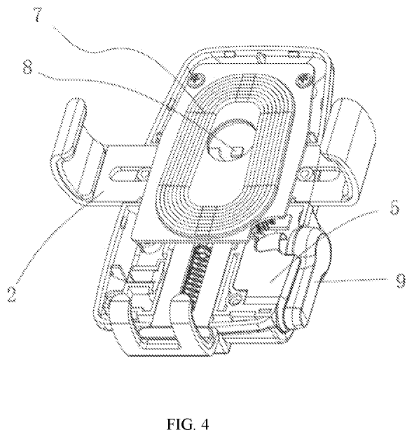

As shown in FIGS. 1-6, a mobile phone holder having a Bluetooth headset module can include a holder body 1, a clamping mechanism 2, a circuit board 3, a power interface 4, a Bluetooth headset 9, a Bluetooth headset holder 5, a drive assembly 6, a wireless charging module 7, and the like. The Bluetooth headset module includes the Bluetooth headset 9 and the Bluetooth headset holder 5. The holder body 1 is constituted by assembling an upper cover plate 11 and a base 12 together. Preferably, the upper cover plate 11 is made of a light-transmissive material so that light of an indicator light 8 arranged in the holder body is transmitted. Preferably, the indicator light 8 is arranged on the circuit board 3 for indicating a working state of the mobile phone holder (e.g., whether the power supply is connected, the charging state of the mobile phone, etc.). A rear face of the base 12 is connected with a fixing device 13 for fixing in the automobile. In the illustrated embodiment, the fixing device 13 is a ball-and-socket jaw structure suitable for fixing to blades of an air outlet of the automobile air conditioner, and its structure is well known and will not be described here. It should be understood that the fixing device 13 may also adopt other structures known in the art.

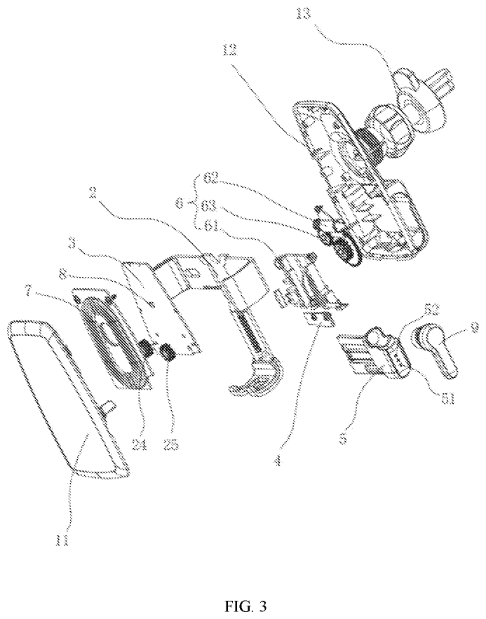

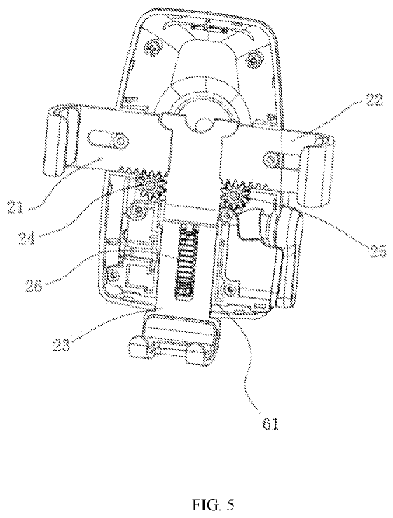

Referring to FIGS. 3 and 5, the clamping mechanism 2 is mounted on the holder body 1 for fixing the mobile phone on the holder body 1. In the illustrated embodiment, the clamping mechanism 2 can include a left holding arm 21, a right holding arm 22, a lower support arm 23, a left gear 24, a right gear 25, and a return spring 26. The left holding arm 21, the right holding arm 22 and the lower support arm 23 are movably mounted on a left side, a right side and a bottom of the holder body 1 respectively, thereby forming a T-shaped structure. Terminals of the left holding arm 21, the right holding arm 22 and the lower support arm 23 are all bent to jam the mobile phone and prevent the mobile phone from slipping off. The left gear 24 and the right gear 25 are rotatably mounted on the circuit board 3. Lower edges of the left holding arm 21 and the right holding arm 22 and left and right edges of the lower support arm 23 are provided with teeth. The left gear 24 is engaged with the lower edge of the left holding arm 21 and the left edge of the lower support arm 23, and the right gear 25 is engaged with the lower edge of the right holding arm 22 and the right edge of the lower support arm 23. That is, the left gear 24 and the right gear 25 are provided at included angles of the left holding arm 21, the right holding arm 22 and the lower support arm 23. An upper end of the return spring 26 is fixed to the lower support arm 23, and a lower end is fixed to a mounting bracket 61 of the drive assembly 6. When the mobile phone is placed on the holder body 1, the lower support arm 23 moves downwardly under gravity of the mobile phone, and the left holding arm 21 and the right holding arm 22 are driven to move toward each other by the left and right gears 24 and 25 to clamp the mobile phone; and when the mobile phone is taken out, the lower support arm 23 moves upwardly under the action of the return spring 26, and the left holding arm 21 and the right holding arm 22 are driven to move oppositely by the left and right gears 24 and 25 to return to the initial position. It should be noted that the clamping mechanism 2 can also be driven by a motor drive mechanism or other means such as magnetic force.

The circuit board 3 is mounted in the holder body 1 and electrically connected with the power interface 4, the Bluetooth headset holder 5, the drive assembly 6 and the wireless charging module 7. The power interface 4 is disposed on the holder body 1 and is used to connect an external power supply to provide power to the circuit board 3, the Bluetooth headset holder 5, the drive assembly 6 and the wireless charging module 7. In this embodiment, the power interface 4 is a type-C interface.

In this embodiment, the Bluetooth headset holder 5 is telescopically mounted on a side face of the holder body 1, that is, the Bluetooth headset holder 5 can extend from the left side or the right side. It should be understood that the Bluetooth headset holder 5 may also be designed to extend forwardly. The Bluetooth headset holder 5 is used to receive the Bluetooth headset 9 and charge the Bluetooth headset. The drive assembly 6 is in drive connection with the Bluetooth headset holder 5. The Bluetooth headset holder 5 is driven to extend under the trigger of the calling signal, and the drive assembly is triggered to drive the Bluetooth headset holder 5 to retract after the Bluetooth headset 9 is put back into the Bluetooth headset holder 5. Specifically, the Bluetooth headset holder 5 is provided with charging contacts 51 (two, positive and negative) and signal contacts 52 for connection with corresponding charging contacts and signal contacts of the Bluetooth headset 9. When the Bluetooth headset 9 is placed on the Bluetooth headset holder 5, the circuit board 3 on the one hand automatically starts a charging program to charge the Bluetooth headset 9, and on the other hand triggers the drive assembly 6 to drive the Bluetooth headset holder 5 to retract when the Bluetooth headset holder is in an extended state. Specifically, the Bluetooth headset 9 starts charging after being put back into the Bluetooth headset holder 5, after the Bluetooth headset 9 detects the start of charging, it sends a retraction signal to the circuit board 3 through the signal contact, and the circuit board 3 controls a motor 62 of the drive assembly 6 to retract the Bluetooth headset 9. The signal contact is used for sending the calling signal of the Bluetooth headset to the circuit board 3, and then triggering the drive assembly 6 to drive the Bluetooth headset holder 5 to extend. Specifically, when an incoming call occurs, the signal contact sends a pulse to a chip of the circuit board 3, and the chip then sends a corresponding command to the motor 62 of the drive assembly 6, then the motor 62 rotates to drive the Bluetooth headset holder 5 to extend. The calling signals can include telephone calling signals and voice and video chat request signals of social software such as WeChat, QQ, etc.

In another embodiment, the calling signal is not sent to the circuit board 3 through the Bluetooth headset 9 and the corresponding signal contacts, but is directly received by a Bluetooth chip (not shown) disposed on the circuit board 3 and triggers the drive assembly 6 to drive the Bluetooth headset holder 5 to extend. In this case, only the charging contacts 51 may be provided on the Bluetooth headset holder 5 without the signal contacts 52.

Preferably, the Bluetooth headset 9 and the Bluetooth headset holder 5 are fixed by a way of magnetic attraction. For example, the Bluetooth headset holder 5 is provided with a permanent magnet (for example, a magnet), and the Bluetooth headset 9 is provided with a ferromagnetic member or a permanent magnet with opposite polarity; and vice versa.

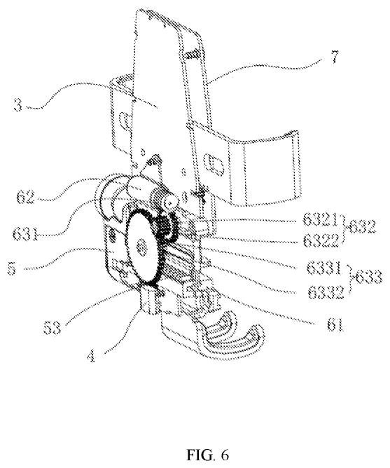

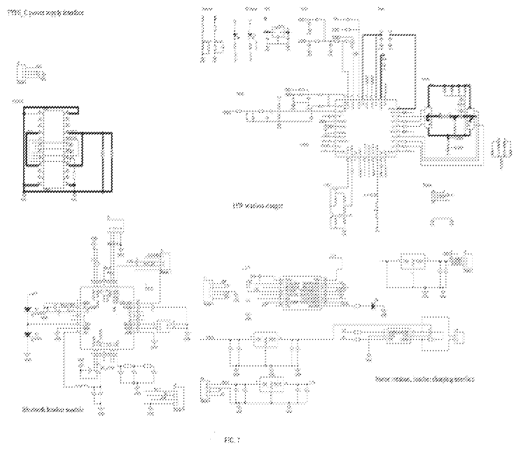

Referring to FIG. 6, the drive assembly 6 can include the mounting bracket 61, the motor 62 and a gear transmission mechanism 63, the mounting bracket 61 is fixedly mounted in the holder body 1 (specifically, on the base 12), the motor 62 is fixedly mounted on the base 12, and the gear transmission mechanism 63 is mounted on the mounting bracket 61. The motor 62 is electrically connected with the circuit board 3 and is in drive connection with the gear transmission mechanism. The Bluetooth headset holder 5 is slidably mounted on the mounting bracket 61 and is provided with a rack 53 that is engaged with the gear transmission mechanism 63. The motor 62 rotates and drives the Bluetooth headset holder 5 to move through the gear transmission mechanism 63.

In the illustrated embodiment, the gear transmission mechanism 63 includes a worm 631, a first gear set 632 and a second gear set 633, the first gear set 632 includes a first large gear 6231 and a first small gear 6322 that are coaxial, the second gear set 633 includes a second large gear 6331 and a second small gear 6332 that are coaxial, the worm 631 is fixedly mounted on an output shaft of the motor 62, the first large gear 6321 is engaged with the worm 631, the first small gear 6322 is engaged with the second large gear 6331, and the second small gear 6332 is engaged with the rack 53. The gear transmission mechanism 63 has a large reduction ratio, so as to smoothly push out and retract the Bluetooth headset holder 5.

The wireless charging module 7 is mounted in the holder body 1, and a wireless charging coil of the wireless charging module 7 is close to a front face of the holder body 1 and is used for charging the mobile phone placed on the holder body 1. The structure of the wireless charging module 7 is well known to those skilled in the art and will not be described here.

According to another aspect of the present invention, there is also provided a driving method of a Bluetooth headset module of a mobile phone holder having a Bluetooth headset module, wherein the structure of the mobile phone holder has been described above and will not be repeated here. The method includes the following steps: triggering the drive assembly 6 through a calling signal to drive the Bluetooth headset holder 5 to extend; and triggering the drive assembly 6 to drive the Bluetooth headset holder 5 to retract after the Bluetooth headset 9 is put back into the Bluetooth headset holder 5. The triggering of the drive assembly 6 to drive the Bluetooth headset holder 5 to extend through the calling signal is realized in two ways, which have also been described above and will not be repeated here.

Although the present invention has been particularly shown and described in conjunction with preferred embodiments, those skilled in the art should understand that various changes in form and detail may be made to the present invention without departing from the spirit and scope of the present invention as defined by the appended claims, which fall within the protection scope of the present invention.

1. A Bluetooth headset module, comprising:
a Bluetooth headset, and
a Bluetooth headset holder, wherein:
the Bluetooth headset holder is telescopically mounted on a mobile phone holder and is configured to receive the Bluetooth headset and charge the Bluetooth headset,
the mobile phone holder is provided with a circuit board and a drive assembly electrically connected with the circuit board,
the circuit board is electrically connected with the Bluetooth headset holder,
the drive assembly is in driving connection with the Bluetooth headset holder,
the Bluetooth headset holder is driven by the drive assembly to extend upon being triggered by a calling signal, and
the drive assembly is triggered to drive the Bluetooth headset holder to retract after the Bluetooth headset is received back into the Bluetooth headset holder.

2. The Bluetooth headset module of claim 1, wherein:
the drive assembly comprises a mounting holder, a motor, and a gear transmission mechanism,
the mounting holder is fixedly mounted in the mobile phone holder,
the gear transmission mechanism is mounted on the mounting holder,
the motor is electrically connected with the circuit board and is in driving connection with the gear transmission mechanism, and
the Bluetooth headset holder is slidably mounted on the mounting holder and is provided with a rack that is engaged with the gear transmission mechanism.

3. The Bluetooth headset module of claim 2, wherein:
the gear transmission mechanism comprises a worm, a first gear set, and a second gear set,
the first gear set comprises a first large gear and a first small gear that are coaxial,
the second gear set comprises a second large gear and a second small gear that are coaxial,
the worm is fixedly mounted on an output shaft of the motor,
the first large gear is engaged with the worm,
the first small gear is engaged with the second large gear, and
the second small gear is engaged with the rack.

4. The Bluetooth headset module of claim 1, wherein:
the Bluetooth headset holder and the Bluetooth headset are respectively provided with charging contacts and signal contacts corresponding to each other,
the charging contacts and the signal contacts are electrically connected with the circuit board,
when receiving the calling signal, the Bluetooth headset sends the calling signal to the circuit board through the signal contacts, thereby triggering the drive assembly to drive the Bluetooth headset holder to extend, and
after the Bluetooth headset is received back into the Bluetooth headset holder, the drive assembly is triggered to drive the Bluetooth headset holder to retract through conduction of the charging contacts.

5. The Bluetooth headset module of claim 1, wherein:
the circuit board is provided with a Bluetooth chip
when receiving the calling signal, the Bluetooth chip triggers the drive assembly to drive the Bluetooth headset holder to extend,
the Bluetooth headset holder and the Bluetooth headset are respectively provided with charging contacts corresponding to each other,
the charging contacts are electrically connected with the circuit board, and
after the Bluetooth headset is received back into the Bluetooth headset holder, the drive assembly is triggered to drive the Bluetooth headset holder to retract through conduction of the charging contacts.

6. A mobile phone holder, wherein: the mobile phone holder has the Bluetooth headset module of claim 1.

7. The mobile phone holder of claim 6, wherein:
the mobile phone holder comprises a holder body and a clamping mechanism,
the holder body is provided with a power interface for connecting an external power supply,
the clamping mechanism is mounted on the holder body for fixing a mobile phone on the holder body,
the circuit board is mounted in the holder body and is electrically connected with the Bluetooth headset holder, the power interface, and the drive assembly, and
the drive assembly is mounted in the holder body.

8. The mobile phone holder of claim 7, wherein:
the clamping mechanism comprises a left holding arm, a right holding arm, a lower support arm, a left gear, a right gear, and a return spring,
the left holding arm, the right holding arm, and the lower support arm are movably mounted on a left side, a right side, and a bottom of the holder body respectively,
the left gear and the right gear are rotatably mounted on the circuit board,
lower edges of the left holding arm and the right holding arm and left and right edges of the lower support arm are provided with teeth,
the left gear is engaged with the lower edge of the left holding arm and the left edge of the lower support arm,
the right gear is engaged with the lower edge of the right holding arm and the right edge of the lower support arm,
an upper end of the return spring is fixed on the lower support arm, and
a lower end of the return spring is fixed on a mounting holder of the drive assembly.

9. The mobile phone holder of claim 7, wherein:
the mobile phone holder further comprises a wireless charging module,
the wireless charging module is mounted in the holder body, and
a wireless charging coil of the wireless charging module is adjacent to a front face of the holder body, is electrically connected with the circuit board, and is used to charge a mobile phone received on the holder body.

10. A driving method of a Bluetooth headset module, comprising the following steps:
providing the Bluetooth headset module, wherein:
the Bluetooth headset module comprises a Bluetooth headset and a Bluetooth headset holder,
the Bluetooth headset holder is telescopically mounted on a mobile phone holder and is configured to receive the Bluetooth headset and charge the Bluetooth headset,
the mobile phone holder is provided with a circuit board and a drive assembly electrically connected with the circuit board,
the circuit board is electrically connected with the Bluetooth headset holder, and
the drive assembly is in driving connection with the Bluetooth headset holder;
triggering the drive assembly through a calling signal to drive the Bluetooth headset holder to extend; and
triggering the drive assembly to drive the Bluetooth headset holder to retract after the Bluetooth headset is received back into the Bluetooth headset holder.

11. The method of claim 10, wherein:
the Bluetooth headset holder and the Bluetooth headset are respectively provided with charging contacts and signal contacts corresponding to each other,
the charging contacts and the signal contacts are electrically connected with the circuit board,
when receiving the calling signal, the Bluetooth headset sends the calling signal to the circuit board through the signal contacts, thereby triggering the drive assembly to drive the Bluetooth headset holder to extend, and
after the Bluetooth headset is received back into the Bluetooth headset holder, the drive assembly is triggered to drive the Bluetooth headset holder to retract through conduction of the charging contacts.

12. The method of claim 10, wherein:
the circuit board is provided with a Bluetooth chip,
when receiving the calling signal, the Bluetooth chip triggers the drive assembly to drive the Bluetooth headset holder to extend,
the Bluetooth headset holder and the Bluetooth headset are respectively provided with charging contacts corresponding to each other,
the charging contacts are electrically connected with the circuit board, and
after the Bluetooth headset is received back into the Bluetooth headset holder, the drive assembly is triggered to drive the Bluetooth headset holder to retract through conduction of the charging contacts.
